(19) United States
(12) Patent Application Publication
(10) Pub. No.: US 2026/0019966 A1
(43) Pub. Date: Jan. 15, 2026

(54) WIRELESS LOCAL AREA NETWORK COORDINATION BASED ON TRANSMIT POWER ENVELOPE CHANGES

(71) Applicant: Cisco Technology, Inc., San Jose, CA (US)

(72) Inventors: Malcolm Muir SMITH, Richardson, TX (US); Brian Donald HART, Sunnydale, CA (US); Anuj DHARAP, Copley, OH (US); Scott Ross BLUE, Oulu (FI); Sachin Dinkar WAKUDKAR, St-Sulpice (CH)

(21) Appl. No.: 18/927,043

(22) Filed: Oct. 25, 2024

Related U.S. Application Data
(60) Provisional application No. 63/671,253, filed on Jul. 14, 2024.

(51) Int. Cl. H04W 52/54; H04W 52/14; H04W 84/12

(52) U.S. Cl. CPC H04W 52/54; H04W 52/143; H04W 84/12

(57) ABSTRACT

In one embodiment, a method herein comprises: determining, by an access point, a future transmit power envelope (TPE) change in a wireless local area network (WLAN); sending, from the access point to a plurality of wireless stations (STAs) within the WLAN, an indication of the future TPE change based on a particular coordination parameter; and performing, by the access point, the future TPE change for the WLAN according to the particular coordination parameter. In another embodiment, a method herein comprises: receiving, by a wireless station (STA) in a wireless local area network (WLAN), an indication of a future transmit power envelope (TPE) change from an access point for the WLAN; determining, by the wireless STA and based on the indication, a particular coordination parameter for the future TPE change; and performing, by the wireless STA, the future TPE change according to the particular coordination parameter.

### TECHNICAL FIELD

The present disclosure relates generally to computer networks, and, more particularly, to wireless local area network (WLAN) coordination based on transmit power envelope (TPE) changes.

### BACKGROUND

The use of 6 GHz frequencies in telecommunications is becoming more and more prevalent. Generally, a device communicating in the 6 GHz band will search an automated frequency coordination (AFC) database on a periodic basis for its location in order to determine which frequencies it can use without causing interference. AFC generally provides yes/no responses for 6 GHz frequency usage according to the Global Positioning System (GPS) location of the specific access point (AP).

For instance, the Institute of Electrical and Electronics Engineers (IEEE) standard 802.11ax, also known as “Wi-Fi 6” (or “WiFi6”), introduces support for the 6 GHz spectrum (WiFi6E) including AFC-governed standard-power (SP). IEEE protocol support for AFC is primarily limited to the transmit power envelope (TPE) Information Element (IE) which is advertised in beacons/probe-responses and includes the local limit (e.g., based on Radio Resource Management (RRM)) as well-as the regulatory limit (e.g., AFC), where the wireless device or station (STA), such as a computer, laptop, or smartphone, is expected to set its maximum transmit power (TXPMax) to the minimum of the two values, i.e., min (Local,Reg).

However, under AFC and IEEE rules the TPE can be updated by any access point (AP) at any time relative to the AFC update (even though regulatory compliance implies otherwise), irrespective of ongoing processes occurring in the WLAN (e.g. RRM transmit power control (TPC) change, inter-AP roam, received signal strength indicator (RSSI) based rate-adaptation, etc.) and lastly the AP has no indication of STA compliance to the advertised TPE (and thus has limited confidence in planning the next RRM action especially if based on reinforcement learning/machine learning). From the point of view of the STA, compliance to min (Local,Reg) can potentially create a fairness issue if all other STAs do not also comply at the same time.

### BRIEF DESCRIPTION OF THE DRA WINGS

The embodiments herein may be better understood by referring to the following description in conjunction with the accompanying drawings in which like reference numerals indicate identically or functionally similar elements, of which:

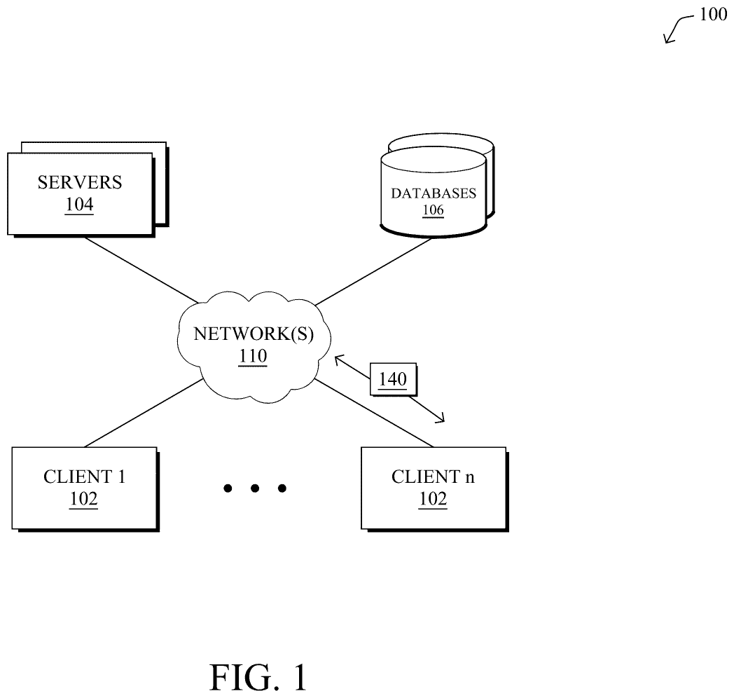

FIG. 1 illustrates an example computing system;

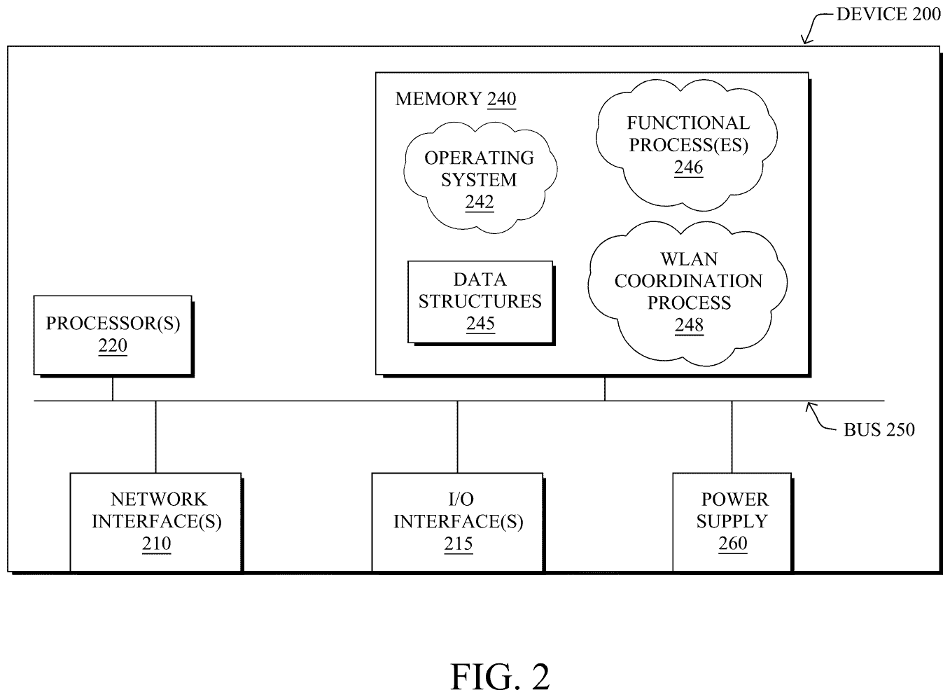

FIG. 2 illustrates an example network device/node;

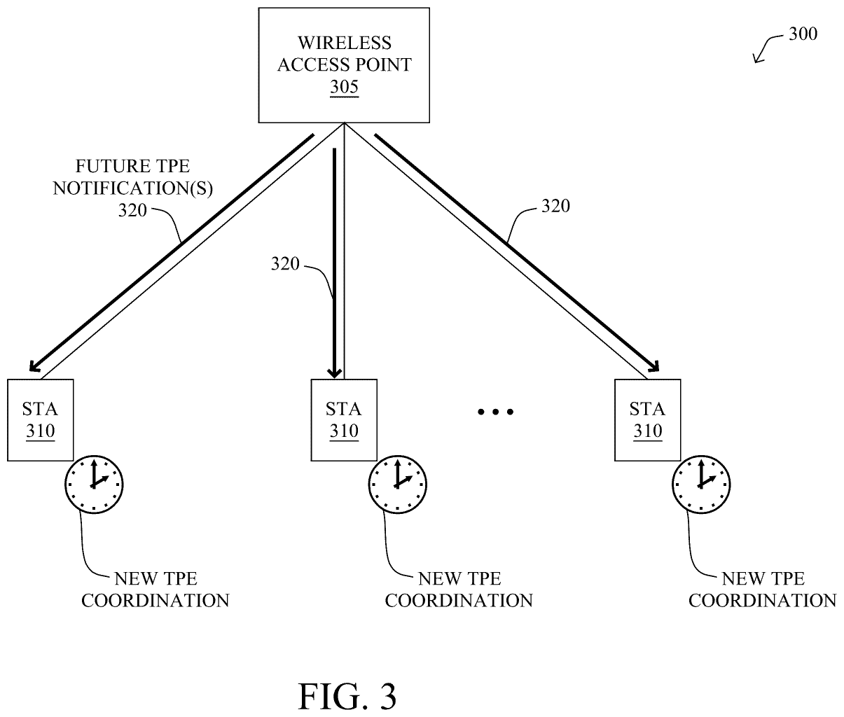

FIG. 3 illustrates an example of a first embodiment for wireless local area network (WLAN) coordination based on transmit power envelope (TPE) changes according to the techniques herein;

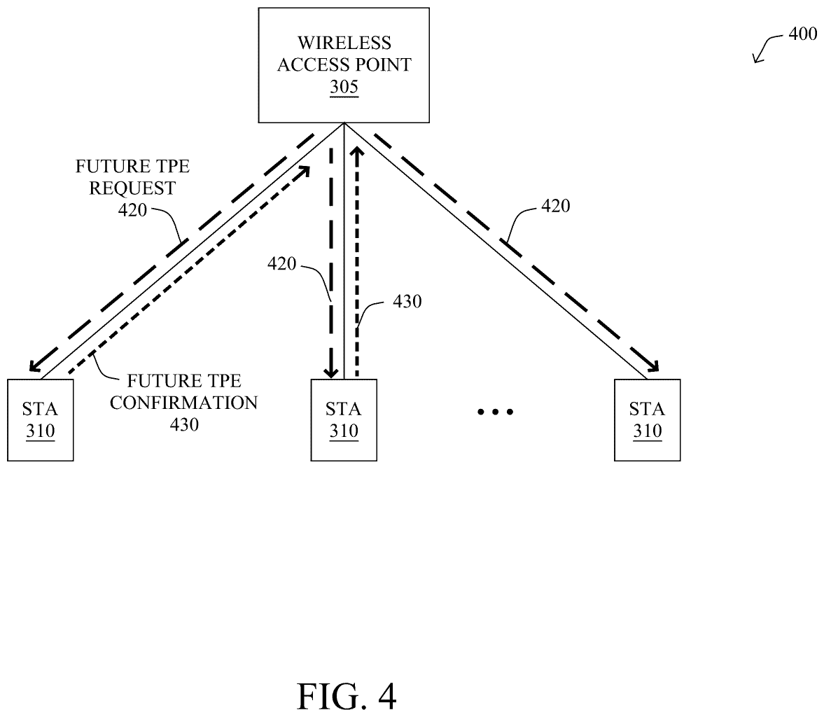

FIG. 4 illustrates an example of a second embodiment for WLAN coordination based on TPE changes according to the techniques herein;

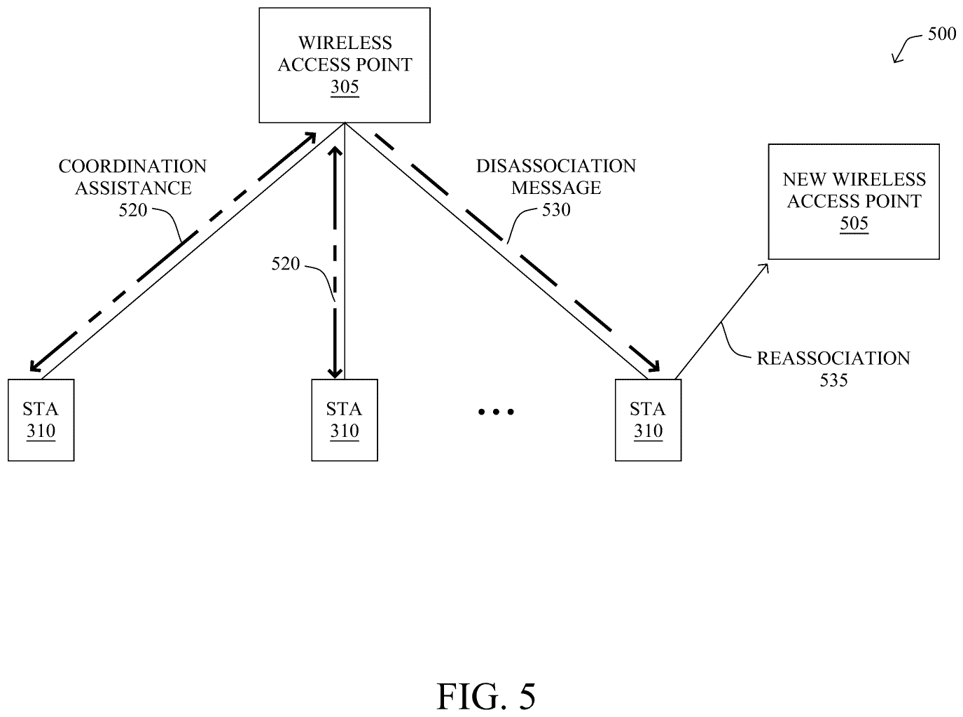

FIG. 5 illustrates an example of a third embodiment for WLAN coordination based on TPE changes according to the techniques herein;

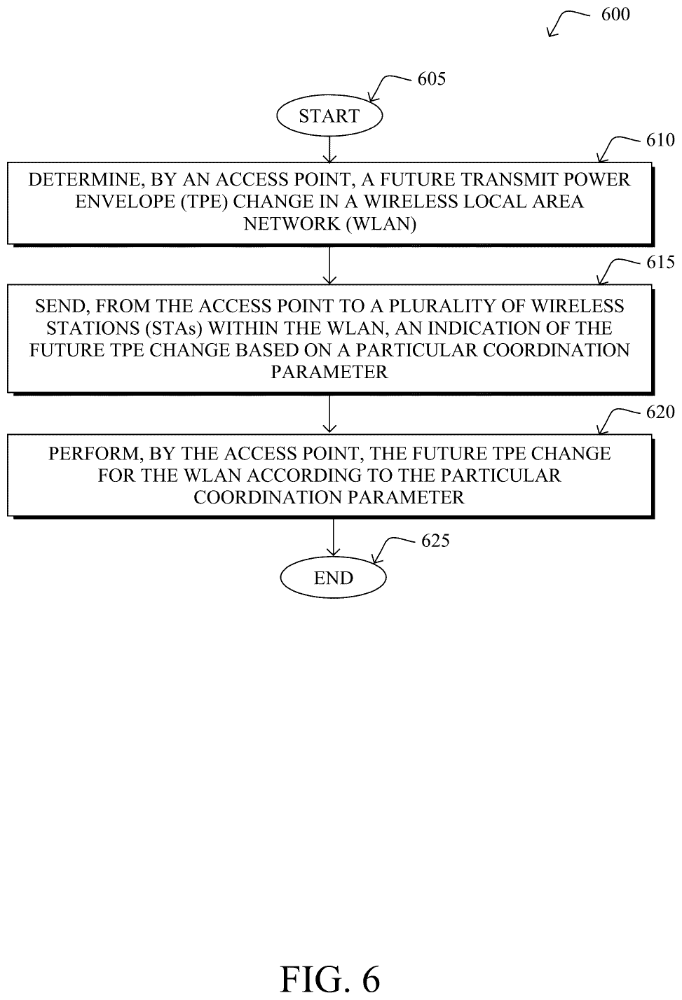

FIG. 6 illustrates an example procedure for WLAN coordination based on TPE changes, particularly from the perspective of an access point; and

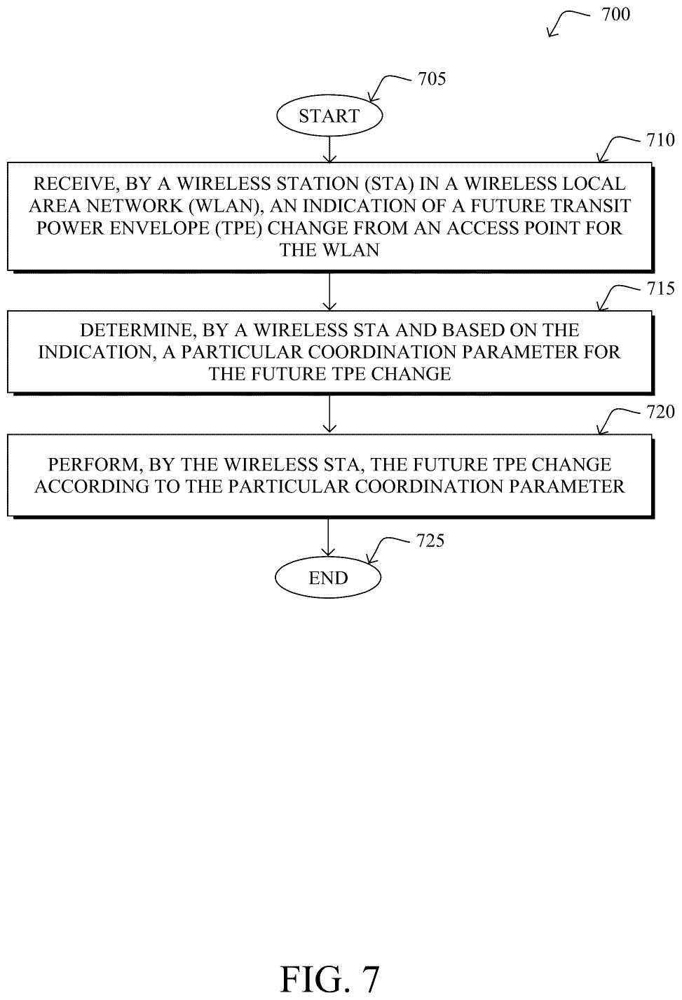

FIG. 7 illustrates an example procedure for WLAN coordination based on TPE changes, particularly from the perspective of a wireless station (STA).

### DESCRIPTION OF EXAMPLE EMBODIMENTS

### Overview

According to one or more embodiments of the disclosure, the techniques herein introduce wireless local area network (WLAN) coordination based on transmit power envelope (TPE) changes as a way to maintain 6 GHz spectrum usage compliance and improve RRM and roaming at the same time. Operationally, the solution described herein incorporates one or more “quid-pro-quo” or “compliance enticement” techniques, each as described in greater detail below.

In one embodiment, a method herein comprises: determining, by an access point, a future transmit power envelope (TPE) change in a wireless local area network (WLAN); sending, from the access point to a plurality of wireless stations (STAs) within the WLAN, an indication of the future TPE change based on a particular coordination parameter; and performing, by the access point, the future TPE change for the WLAN according to the particular coordination parameter.

In another embodiment, a method herein comprises: receiving, by a wireless station (STA) in a wireless local area network (WLAN), an indication of a future transmit power envelope (TPE) change from an access point for the WLAN; determining, by the wireless STA and based on the indication, a particular coordination parameter for the future TPE change; and performing, by the wireless STA, the future TPE change according to the particular coordination parameter.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Network(s) 110 may include, for example, network backbones or other internetworking systems, and may include various customer edge (CE) routers interconnected with provider edge (PE) routers in order to communicate across a core network to provide connectivity between devices which may be located in different geographical areas and/or on different types of local networks (e.g., local/branch networks versus data center/cloud environments). For example, these routers may be interconnected by the public Internet, a multiprotocol label switching (MPLS) virtual private network (VPN), or the like. In some implementations, a router or a set of routers may be connected to a private network (e.g., dedicated leased lines, an optical network, etc.) or a VPN (e.g., MPLS VPN) thanks to a carrier network, via one or more links exhibiting different network and service level agreement characteristics.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly. For instance, servers 104 may include, in various implementations, a network management server (NMS), a dynamic host configuration protocol (DHCP) server, a constrained application protocol (CoAP) server, an outage management system (OMS), an application policy infrastructure controller (APIC), an application server, etc.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

For instance, smart object networks, such as sensor networks, in particular, are a specific type of network (e.g., computing system 100) having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Generally, size and cost constraints on smart object nodes (e.g., sensors) result in corresponding constraints on resources such as energy, memory, computational speed and bandwidth.

In some implementations, the techniques herein may be applied to still other network topologies and configurations. For example, the techniques herein may be applied to peering points with high-speed links, data centers, etc.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

According to various implementations, a software-defined WAN (SD-WAN) may be used in computing system 100 to connect local networks and data center/cloud environments. In general, an SD-WAN uses a software defined networking (SDN)-based approach to instantiate tunnels on top of the physical network and control routing decisions, accordingly. For example, one tunnel may connect a customer edge (CE) router at the edge of a local network to router a remote CE router at the edge of a data center/cloud environment over an MPLS or Internet-based service provider network in a network backbone. Similarly, a second tunnel may also connect these routers over a 4G/5G/LTE cellular service provider network. SD-WAN techniques allow the WAN functions to be virtualized, essentially forming a virtual connection between local networks and data center/cloud environments on top of the various underlying connections. Another feature of SD-WAN is centralized management by a supervisory service that can monitor and adjust the various connections, as needed.

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, a WLAN coordination process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

For instance, one or more functional processes 246 may include computer executable instructions executed by the processor(s) 220 to perform routing functions in conjunction with one or more routing protocols. These functions may, on capable devices, be configured to manage a routing/forwarding table (a data structure 245) containing, e.g., data used to make routing/forwarding decisions.

In general, WLAN coordination process (process 248) may specifically include computer-executable instructions executable by processor(s) 220 to perform functions related to mobile device roaming from one wireless access point to another. To this end, WLAN coordination process (process 248) may operate in conjunction with one or more functional processes 246 and in accordance with one or more protocols (e.g., IEEE 802.11ax, Control and Provisioning of Wireless Access Points (CAPWAP), and so on).

In various implementations, as detailed further below, one or more functional processes 246 and/or WLAN coordination process (process 248) may include computer executable instructions that, when executed by processor(s) 220, cause device 200 to perform the techniques described herein. It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

### —WLAN Coordination Based on TPE Changes—

As noted above, the Institute of Electrical and Electronics Engineers (IEEE) standard 802.11ax, also known as “Wi-Fi 6” (or “WiFi6”), introduces support for the 6 GHz spectrum (WiFi6E) including AFC-governed standard-power (SP). Further, in the U.S., the Federal Communications Commission (FCC) has mandated the use of automated frequency coordination (AFC), in order to communicate in the 6 GHz band. Under the current requirement, a device communicating in the 6 GHz band will need to search an AFC database on a periodic (e.g., daily, weekly, monthly) basis for its location to determine which frequencies it can use without causing interference. More specifically, AFC provides yay/nay responses for 6 GHz frequency usage according to the Global Positioning System (GPS) location of the specific access point (AP).

As used herein, an “automated frequency coordination service” or “automated frequency coordination protocol,” as well as variants thereof, generally refers to a spectrum use coordination system that consists of a registered database of all the bands in use by various types of radio frequency services in a particular area. It may be used by Wi-Fi access points (APs), especially those that operate in the newly allocated 6 GHz band (5.925-7.125 GHz). An automated frequency coordination service can further contain a database of existing 6 GHz operators, including geolocation, frequencies, power levels, antenna coverage, etc. (While certain embodiments are described herein with respect to automated frequency coordination to support 6 GHz communication, embodiments are not so limited, and, in particular, other communication bands that use automated frequency coordination or similar techniques, particularly outside of the US, may also benefit from the techniques described herein.)

As also noted above, IEEE protocol support for AFC is primarily limited to the transmit power envelope (TPE) Information Element (IE) which is advertised in beacons/probe-responses and includes the local limit (e.g., based on Radio Resource Management (RRM)) as well-as the regulatory limit (e.g., AFC), where the wireless device or station (STA) is expected to set its maximum transmit power (TXPMax) to the minimum of the two values, i.e., min (Local,Reg). As further noted, under AFC and IEEE rules the TPE can be updated by any access point (AP) at any time relative to the AFC update, irrespective of ongoing processes occurring in the WLAN (e.g. RRM transmit power control (TPC) change, inter-AP roam, received signal strength indicator (RSSI) based rate-adaptation, etc.) and lastly the AP has no indication of STA compliance to the advertised TPE (and thus has limited confidence in planning the next RRM action especially if based on reinforcement learning/machine learning). From the point of view of the STA, compliance to min (Local,Reg) can potentially create a fairness issue if all other STAs do not also comply at the same time.

Many problems exist from this situation. For example:
Different APs under the same or neighboring WLAN could advertise or use different TPEs (especially standard power (SP) or low-power indoor (LPI)) at different times:
   e.g., a STA associated to AP1 uses SP power for a few seconds after an AFC TPE change (e.g., due to an internal co-ex conflict or roam process);
   e.g., a STA associated with AP1 uses SP but its neighbor AP2 down-powers to LPI changing the signal-to-interference-plus-noise ratio (SINR) significantly;
   e.g., an AP is no longer allowed AFC SP so changes to LPI causing significant instantaneous coverage gaps with STAs.
Different STAs comply or not-comply with TPE at different times:
   e.g., device class A experiences a drop in throughput but device class B does not;
   e.g., RRM Coverage Hole detection needs to accommodate wide STA TXP range (sub-optimal).
A STA is in the process of roaming (e.g., by measuring beacon reports) while the TPE changes:
   e.g., Beacon power on the target AP the STA is roaming to lowers by 10 dB invalidating it as a better candidate, the STA needs to restart scans.
A STA and AP are in the post-convergence phase of a dynamic rate-adaptation (DRA) process:
   e.g., the AP advertises a new TPE (e.g. 10 dB lower) which the STA complies with and its MAC Protocol Data Unit (MPDU) now cannot be decoded causing DRA re-start.

It should be clear that a better method of power management, especially with regard to regulatory power, is needed that avoids delay in executing TPE changes but also respects the needs of the STA to complete critical tasks before a TPE change and be treated fairly.

The techniques herein, therefore, introduce wireless local area network (WLAN) coordination based on transmit power envelope (TPE) changes as a way to maintain 6 GHz spectrum usage compliance and improve RRM and roaming at the same time.

Operationally, the solution described herein incorporates one or more “quid-pro-quo” or “compliance enticement” techniques, each as described in greater detail below.

In one embodiment, TPE changes (especially regulatory) may be scheduled and announced in advance (including in one embodiment the new-to-be TPE) across all similarly affected APs in the WLAN, e.g. 500 ms or five beacon intervals (BIs), or two to three seconds (e.g., to account for sleeping devices). This gives all STAs the heads-up to stop/defer any operations affected such as roaming. It also means all STAs act at the same time giving no advantage to one or the other (e.g., due to associated AP or vendor-specific TPE response time). The schedule includes the time the TPE will change (e.g., timing synchronization function (TSF) or count-down of ‘x’ beacons ahead) and an optional time window for STA to confirm (e.g., ‘x’ BIs after scheduled time). In some embodiments, an actual TPE update is sent (e.g., beacon, action frame, etc.) and in some it is implied by the scheduled TPE itself. In both cases, the new TPE can be sent in the schedule since the value is known. The AP can request confirmation in the schedule or update message (e.g., under low-density, only for Regulatory changes, etc.).

FIG. 3 illustrates an example of this first embodiment for WLAN coordination based on TPE changes according to the techniques herein. As shown in an illustrative simplified network 300, a wireless access point 305 is in communication (e.g., within a WLAN) with a plurality of wireless clients “STA 310” as shown. In this embodiment, the access point acts as the control for the future TPE change (e.g., “take it or leave it”), where a future TPE notification 320 is sent to the STAs within the WLAN to indicate when, and optionally what, future TPEs will occur. For instance, a specific time (e.g., absolute, such as 5:00 am, or counter-based, e.g., 500 ms, 1 hour, and so on) may be indicated, or else various other coordinated timing specifications may be made, such as sequence numbers of TPE beacons (e.g., when beacon “1234567” is received), a countdown within beacons (e.g., “5 beacons”, “4 beacons”, “3 beacons” . . . “this beacon”), where the TPE change may be indicated in advance for preparation, and/or may be carried within an updated TPE.

In another embodiment, TPE change confirmations may be optionally requested by APs and optionally confirmed by STAs. This IE confirms the application of the TPE (either the Reg or Local) and (optionally) the actual TXP (though notably this may be considered competitive intel).

FIG. 4 illustrates an example of this second embodiment for WLAN coordination based on TPE changes according to the techniques herein. In particular, in this simplified network 400, STAs are involved in more of a negotiation to make sure the STAs are aware of the TPE change. For example, a future TPE request 420 may be sent from the wireless access point 305 to each STA 310 (e.g., in an action frame or a beacon, etc.), or other channel switch elements configured to carry TPE counters or future TPE timing, accordingly. In one embodiment, performing the future TPE change may be based on receiving confirmation (future TPE confirmation 430) from the STAs (e.g., all or a threshold amount of the STAs in the WLAN/currently associated with the access point). Note that this acknowledgment (ACK) based methodology may be better suited for smaller numbers of clients than larger numbers.

In still another embodiment, TPE changes may be coordinated between WLAN/APs and STAs to avoid service disruption and STA disparities. STAs who comply (confirm) can be treated to a better experience as the AP/WLAN can perform the following (knowing the enactment of the new TXP):
immediately update RRM (e.g., coverage hole) given new TXP (no need to wait for RSSI data collection and TXP guesswork);
immediately update the per-AP neighbor-list given new TXP (no need to probe APs that are too far away);
defer Basic Service Set (BSS) Transition Management (BTM) Disconnect Imminent (or similar “sticky” client methods) knowing the new reduced or increased coverage;
adjust stream classification service (SCS), traffic specification (TSPEC), reserved/restricted target wait time (R-TWT), and similar scheduled services affected by changes in data-rate (rather than wait for DRA failure).

Note that any unconfirmed STAs may be treated in a way to ensure regulatory compliance and may receive BTM Imminent/de-auth as appropriate, especially if operating in SP while associated now with an LPI-only AP.

FIG. 5 illustrates an example of this third embodiment for WLAN coordination based on TPE changes according to the techniques herein. In particular, in this simplified network 500, a “quid pro quo” exchange is offered, where an opportunity to better understand the environment is established through such coordination. That is, communication messages (coordination assistance 520), such as beacons, client responses to beacons, unsolicited neighbor reports/responses, BTM query frames, and so on, may be used to collectively help obtain and distribute information useful in creating new TPE changes. For instance, when converge holes occur (e.g., an access point goes offline), the devices within the WLAN need to react, and this coordination helps mitigate jarring reactions by waiting for a complete picture before adjusting any TPE parameters, accordingly.

As also shown, the wireless access point 305 may also send a disassociation request (disassociation message 530) to one or more unconfirming STAs (notably in this embodiment or either of the two embodiments above), forcing them to reassociate (reassociation 535) with a new wireless access point 505, accordingly.

Notably, any combination of each of the above embodiments are also contemplated here, and each embodiment above is not meant to be mutually excusive of one another, accordingly.

According to embodiments herein, various carriers for these messages above are possible. For instance, in one embodiment, a new Spectrum Management action type (e.g., scheduled TPC) may be defined (e.g., using a new reserved value within the spectrum management action field). In another embodiment, an extension to an existing Spectrum Management action, such as Channel Switch Announcement (CSA), may be used as an in-place method herein (e.g., an extension to change mode or power as opposed to, or in addition to, a channel). In still another embodiment, an extension to a TPE in a beacon/probe-response may be used, and may be useful due to 6 GHz compliance (and particularly if future TPE changes are based on BI boundaries).

In closing, FIG. 6 illustrates an example simplified procedure for wireless local area network (WLAN) coordination based on transmit power envelope (TPE) changes in accordance with one or more embodiments described herein, particularly from the perspective of an access point. For example, a non-generic, specifically configured device (e.g., device 200, an apparatus) may perform procedure 600 by executing stored instructions (e.g., process 248). The procedure 600 may start at step 605, and continues to step 610, where, as described in greater detail above, an access point may determine a future transmit power envelope (TPE) change in a wireless local area network (WLAN) (e.g., based on AFC or otherwise).

In step 615, the access point may send, to a plurality of wireless stations (STAs) within the WLAN, an indication of the future TPE change based on a particular coordination parameter. In one embodiment, the coordination parameter may be a scheduled time such as an absolute time, a countdown timer, a number of beacon intervals, etc. In other embodiments, the coordination parameter may be a request-response (confirmation) exchange, or may be other coordination conditions, as described above.

In step 620, the access point may perform the future TPE change for the WLAN according to the particular coordination parameter (e.g., changing the TPE, sending an updated TPE according to the particular coordination parameter, etc.). Optionally, too, the access point may also send coordination assistance to one or more STAs for the future TPE change, as described above, either as part of sending the indication of the future TPE change, or else in response to confirmation/coordination from certain wireless clients (STAs).

Procedure 600 may end at step 625.

Additionally, FIG. 7 illustrates an example simplified procedure for wireless local area network (WLAN) coordination based on transmit power envelope (TPE) changes in accordance with one or more embodiments described herein, particularly from the perspective of a wireless station (STA). For example, a non-generic, specifically configured device (e.g., device 200, an apparatus) may perform procedure 700 by executing stored instructions (e.g., process 248). The procedure 700 may start at step 705, and continues to step 710, where, as described in greater detail above, a wireless station (STA) in a wireless local area network (WLAN) receives an indication of a future transmit power envelope (TPE) change from an access point for the WLAN. As noted above, this indication may be a directive, a request, and/or a coordination from the access point.

In step 715, the wireless STA may determine, based on the indication, a particular coordination parameter for the future TPE change. As mentioned, the coordination parameter may be a scheduled time, a request for a confirmation, or other coordination parameters.

In step 720, the wireless STA may perform the future TPE change according to the particular coordination parameter (e.g., based on previously receiving the TPE itself in the indication, or else in response to later receiving a new TPE from the access point at the coordinated time, and so on).

Procedure 700 may end at step 725.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative method herein may comprise: determining, by an access point, a future transmit power envelope (TPE) change in a wireless local area network (WLAN); sending, from the access point to a plurality of wireless stations (STAs) within the WLAN, an indication of the future TPE change based on a particular coordination parameter; and performing, by the access point, the future TPE change for the WLAN according to the particular coordination parameter.

In one embodiment, the particular coordination parameter comprises a scheduled time. In one embodiment, the scheduled time is one of either an absolute time, a countdown timer, or a number of beacon intervals.

In one embodiment, the method further comprises: receiving a confirmation from one or more of the plurality of STAs. In one embodiment, performing the future TPE change is based on receiving confirmation from the one or more of the plurality of STAs. In one embodiment, performing the future TPE change is based on receiving confirmation from a threshold amount of the plurality of STAs. In one embodiment, the method further comprises sending a disassociation request to one or more unconfirming STAs of the plurality of STAs.

In one embodiment, the method further comprises: sending coordination assistance to one or more STAs for the future TPE change. In one embodiment, sending the coordination assistance comprises sending the coordination assistance to one or more of the plurality of STAs from which a confirmation is received by the access point regarding the future TPE. In one embodiment, the coordination assistance is selected from a group consisting of: Radio Resource Management (RRM) updates based on a new transmit power; per-access-point neighbor-list updates based on the new transmit power; deferral of Basic Service Set (BSS) Transition Management (BTM) Disconnect Imminent messages; adjustment to stream classification service (SCS) based on changes in data-rate due to the future TPE change; adjustment to traffic specification (TSPEC) based on changes in data-rate due to the future TPE change; and adjustment to reserved/restricted target wait time (R-TWT) based on changes in data-rate due to the future TPE change.

In one embodiment, sending comprises including a new TPE within the indication.

In one embodiment, performing comprises sending an updated TPE according to the particular coordination parameter.

In some implementations, an illustrative apparatus herein may comprise: one or more network interfaces to communicate with a network; a processor coupled to the one or more network interfaces and configured to execute one or more processes; and a memory configured to store a process that is executable by the processor, the process comprising: determining, by an access point, a future transmit power envelope (TPE) change in a wireless local area network (WLAN); sending, from the access point to a plurality of wireless stations (STAs) within the WLAN, an indication of the future TPE change based on a particular coordination parameter; and performing, by the access point, the future TPE change for the WLAN according to the particular coordination parameter.

In still other implementations, a tangible, non-transitory, computer-readable medium storing program instructions that cause a device to execute a process comprising: determining, by an access point, a future transmit power envelope (TPE) change in a wireless local area network (WLAN); sending, from the access point to a plurality of wireless stations (STAs) within the WLAN, an indication of the future TPE change based on a particular coordination parameter; and performing, by the access point, the future TPE change for the WLAN according to the particular coordination parameter.

In some implementations, another illustrative method herein may comprise: receiving, by a wireless station (STA) in a wireless local area network (WLAN), an indication of a future transmit power envelope (TPE) change from an access point for the WLAN; determining, by the wireless STA and based on the indication, a particular coordination parameter for the future TPE change; and performing, by the wireless STA, the future TPE change according to the particular coordination parameter.

In one embodiment, the particular coordination parameter comprises a scheduled time. In one embodiment, the scheduled time is one of either an absolute time, a countdown timer, or a number of beacon intervals.

In one embodiment, the method further comprises: sending a confirmation for the future TPE change to the access point. In one embodiment, performing the future TPE change is based on the access point receiving confirmation from a threshold amount of the plurality of STAs.

In one embodiment, the method further comprises: receiving coordination assistance for the future TPE change from the access point.

In one embodiment, a new TPE is included within the indication.

In some implementations, another illustrative apparatus herein may comprise: one or more network interfaces to communicate with a wireless local area network (WLAN); a processor coupled to the one or more network interfaces and configured to execute one or more processes; and a memory configured to store a process that is executable by the processor, the process comprising: receiving, as a wireless station (STA) in the WLAN, an indication of a future transmit power envelope (TPE) change from an access point for the WLAN; determining, by the wireless STA and based on the indication, a particular coordination parameter for the future TPE change; and performing, by the wireless STA, the future TPE change according to the particular coordination parameter.

In still other implementations, another tangible, non-transitory, computer-readable medium storing program instructions that cause a device to execute a process comprising: receiving, by a wireless station (STA) in a wireless local area network (WLAN), an indication of a future transmit power envelope (TPE) change from an access point for the WLAN; determining, by the wireless STA and based on the indication, a particular coordination parameter for the future TPE change; and performing, by the wireless STA, the future TPE change according to the particular coordination parameter.

The techniques described herein, therefore, provide for wireless local area network (WLAN) coordination based on transmit power envelope (TPE) changes. In particular, the techniques herein offer a relatively low-complexity solution to a market problem to schedule a TPE change and coordinate the implementation. That is, the techniques herein illustratively manage AFC for operation of an AP (e.g., in the 6 GHz band), on a “not-to-interfere” basis with incumbent fixed stations, where in the event that the AFC changes the TPE value, the techniques herein can schedule and announce the change in advance, optionally defining confirmation request-and-response messages between the affected APs and the associated clients, and also optionally by coordinating the TPE by the affected APs with their clients.

As will be appreciated by those skilled in the art, for US operation (and similarly so in non-US jurisdictions), the AFC system would use data from the Universal Licensing System (ULS) database for determining the location of incumbent fixed microwave operations for purposes of establishing the exclusion zones. The ULS database is expected to change either due to addition/removal of incumbents, applying the correction to parameters that would impact channel availability and power levels. Hence, AFC operators are supposed to download ULS database on a daily basis and devices are supposed to reach out to an AFC server on a daily basis to verify channel availability and associated power levels. It is also obligatory that database is kept up to date and can be changed/corrected/updated and expected to be used in the next renewal of AFC license. This is by no means a rare event, and the techniques herein may thus be used to accommodate (e.g., and enforce) these fundamental AFC requirements.

The techniques herein, in particular, reduce or eliminate many issues associated with the current state of TPE changes, such as roaming coordination, topology changes (and thus network stability), uncoordinated TPE changes, and TPE change enforcement (e.g., time bounds for confirmation of change adherence). That is, the techniques herein address how different clients/STAs may react/behave differently to TPE/mode changes.

Illustratively, the techniques described herein may be performed by hardware, software, and/or firmware, (e.g., an “apparatus”) such as in accordance with the WLAN coordination process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly.

In particular, while certain wireless protocols have been mentioned, such as automated frequency coordination (AFC), 6 GHz frequencies, 802.11ax (Wi-Fi 6), and so on, these are not meant to be limiting to the scope of the present disclosure, and any suitable wireless protocol for any type of device and network that can benefit from the future TPE coordination techniques described herein, such as IEEE 802.11bn (“Wi-Fi 8”) and beyond, may make use of the techniques herein and are contemplated to be encompassed by the scope of the claims herein unless otherwise specifically so limited.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
determining, by an access point, a future transmit power envelope change in a wireless local area network;
sending, from the access point to a plurality of wireless stations within the wireless local area network, an indication of the future transmit power envelope change based on a particular coordination parameter; and
performing, by the access point, the future transmit power envelope change for the wireless local area network according to the particular coordination parameter.

2. The method as in claim 1, wherein the particular coordination parameter comprises a scheduled time.

3. The method as in claim 2, wherein the scheduled time is one of either an absolute time, a countdown timer, or a number of beacon intervals.

4. The method as in claim 1, wherein the method further comprises:
receiving a confirmation from one or more of the plurality of wireless stations.

5. The method as in claim 4, wherein performing the future transmit power envelope change is based on receiving confirmation from one or more of the plurality of wireless stations.

6. The method as in claim 4, wherein performing the future transmit power envelope change is based on receiving confirmation from a threshold amount of the plurality of wireless stations.

7. The method as in claim 4, wherein the method further comprises:
sending a disassociation request to one or more unconfirming wireless stations of the plurality of wireless stations.

8. The method as in claim 1, wherein the method further comprises:
sending coordination assistance to one or more wireless stations for the future transmit power envelope change.

9. The method as in claim 8, wherein sending the coordination assistance comprises:
sending the coordination assistance to one or more of the plurality of wireless stations from which a confirmation is received by the access point regarding the future transmit power envelope change.

10. The method as in claim 8, wherein the coordination assistance is selected from a group consisting of: Radio Resource Management updates based on a new transmit power; per-access-point neighbor-list updates based on the new transmit power; deferral of Basic Service Set Transition Management Disconnect Imminent messages; adjustment to stream classification service based on changes in data-rate due to the future transmit power envelope change; adjustment to traffic specification based on changes in data-rate due to the future transmit power envelope change; and adjustment to restricted target wait time based on changes in data-rate due to the future transmit power envelope change.

11. The method as in claim 1, wherein sending comprises:
including a new transmit power envelope within the indication.

12. The method as in claim 1, wherein performing comprises:
sending an updated transmit power envelope according to the particular coordination parameter.

13. A method, comprising:
receiving, by a wireless station in a wireless local area network, an indication of a future transmit power envelope change from an access point for the wireless local area network;
determining, by the wireless station and based on the indication, a particular coordination parameter for the future transmit power envelope change; and
performing, by the wireless station, the future transmit power envelope change according to the particular coordination parameter.

14. The method as in claim 13, wherein the particular coordination parameter comprises a scheduled time.

15. The method as in claim 14, wherein the scheduled time is one of either an absolute time, a countdown timer, or a number of beacon intervals.

16. The method as in claim 13, further comprising:
sending a confirmation for the future transmit power envelope change to the access point.

17. The method as in claim 16, wherein performing the future transmit power envelope change is based on the access point receiving confirmation from a threshold amount of wireless stations within the wireless local area network.

18. The method as in claim 13, further comprising:
receiving coordination assistance for the future transmit power envelope change from the access point.

19. The method as in claim 13, wherein a new transmit power envelope is included within the indication.

20. An apparatus, comprising:
one or more network interfaces to communicate with a wireless local area network;
a processor coupled to the one or more network interfaces and configured to execute one or more processes; and
a memory configured to store a process that is executable by the processor, the process comprising:
receiving, as a wireless station in the wireless local area network, an indication of a future transmit power envelope change from an access point for the wireless local area network;
determining, by the wireless station and based on the indication, a particular coordination parameter for the future transmit power envelope change; and
performing, by the wireless station, the future transmit power envelope change according to the particular coordination parameter.
